(19) United States
(12) Patent Application Publication
(10) Pub. No.: US 2009/0068579 A1
(43) Pub. Date: Mar. 12, 2009

(54) FULL-COLOR TONER FOR ELECTROPHOTOGRAPHY, AND PRODUCTION METHOD FOR THE SAME

(76) Inventors: Satoshi OGAWA, Nara-shi (JP); Mitsuo Aoki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/208,801

(22) Filed: Sep. 11, 2008

(30) Foreign Application Priority Data
Sep. 12, 2007 (JP) 2007-236813
Jan. 25, 2008 (JP) 2008-014678

(51) Int. Cl. G03G 9/087; G03G 9/16

(52) U.S. Cl. 430/108.4

(57) ABSTRACT

A production method for a full-color toner for electrophotography includes melt-kneading a toner material by use of an open-roll kneader, the toner material containing at least a binder resin, a wax, a colorant, and a charge control agent, wherein Mze/Mzi is 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and wherein a zirconium compound of a salicylic acid derivative is used as the charge control agent.

### BACKGROUND OF THE INVENTION

1. Field of the Invention

The present invention relates to a toner used for electrophotography, more particularly to a full-color toner for electrophotography for use in image forming apparatus employing so-called electrophotography, including electrostatic copiers and laser beam printers, and a production method for the same.

2. Description of the Related Art

In a recent hardcopy technology that relies on electrophotography, there is an increasing demand for monochrome printing to reduce power consumption as it is becoming widely available. Moreover, in order to achieve high-speed printing as well as simplification and stabilization of the fixing system, demand has arisen for black toner for monochrome printing, which has a low fixing temperature and wide fixing temperature range. To meet these requirements binder resins have been developed that have low melting points and sharp melt characteristics. In order to assure these characteristics, however, a large amount of wax needs to be added as a releasing agent. Under such circumstances, many inventions have been made that aim to allow a large amount of wax, which is incompatible with binder resin, to be present in the toner while keeping the wax to be highly uniformly dispersed in the binder resin.

As an example of such an invention directed to a toner production method, Japanese Patent (JP-B) No. 3366576 discloses that the dispersibility of wax and other agents increases by kneading with an open-roll kneader. The open-roll kneader is capable of kneading at low temperatures and, therefore, the materials are kneaded with their elasticity kept high. This results in application of high shearing force to the materials and thus increases their dispersibility. However, the molecules of the crosslinked portions of resin undergo partial breakage, leading to reduced high-temperature offset resistance. Japanese Patent Application Laid-Open (JP-A) No. 2001-290307 discloses exploiting molecular breakage effected by means of an open-roll kneader for the production of a toner with excellent low-temperature fixing property and high transparency. JP-A No. 2007-79147 discloses that a toner with highly dispersed wax can be prepared by establishing a kneaded state where the viscoelasticitiy of the kneaded toner materials at the discharge port of an open-roll kneader is smaller than that of the toner material at the supply port. The invention, however, remains silent with respect to fixing ability at high temperatures. Hot offset becomes more likely to occur if molecular breakage occurred as a result of attempting to ensure excellent dispersibility or low-temperature fixing property.

### BRIEF SUMMARY OF THE INVENTION

The present invention was made in view of the foregoing problems pertinent in the art, and an object thereof is to provide a toner which has excellent low-temperature fixing property, high transparency and high hot offset resistance and in which toner materials such as a wax, a colorant, and a charge control agent are highly uniformly dispersed to prevent image disturbance and to provide excellent charge rising property.

Means for solving the foregoing problems are as follows:

<1> A production method for a full-color toner for electrophotography, including:

melt-kneading a toner material by use of an open-roll kneader, the toner material containing at least a binder resin, a wax, a colorant, and a charge control agent,

wherein Mze/Mzi is 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and

wherein a zirconium compound of a salicylic acid derivative is used as the charge control agent.

<2> The production method according to <1>, wherein the charge control agent is added in an amount of 0.5 parts by mass to 3 parts by mass per 100 parts by mass of the resin.
<3> The production method according to <1> or <2>, wherein the charge control agent, exposed on a toner surface, has an average particle diameter of 0.7 μm or less.
<4> The production method according to any one of <1> to <3>, wherein a polyester resin is used as the binder resin.
<5> The production method according to any one of <1> to <4>, wherein the binder resin has an acid value of 10 mgKOH/g to 30 mgKOH/g.
<6> A full-color toner for electrophotography including:

a binder resin;

a wax;

a colorant; and

a charge control agent,

wherein the toner is produced by melt-kneading using an open-roll kneader,

wherein Mze/Mzi is 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and

wherein a zirconium compound of a salicylic acid derivative is used as the charge control agent.

<7> The full-color toner according to <6>, wherein the charge control agent is added in an amount of 0.5 parts by mass to 3 parts by mass per 100 parts by mass of the resin.
<8> The full-color toner to <6> or <7>, wherein the charge control agent, exposed on a toner surface, has an average particle diameter of 0.7 μm or less.
<9> The full-color toner according to any one of <6> to <8>, wherein a polyester resin is used as the binder resin.
<10> The full-color toner according to <6> to <9>, wherein the binder resin has an acid value of 10 mgKOH/g to 30 mg/KOH/g.

The present invention is directed to a production method for a full-color toner for electrophotography, which the method includes melt-kneading a toner material by use of an open-roll kneader, the toner material containing at least a binder resin, a wax, a colorant, and a charge control agent, wherein Mze/Mzi is 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and wherein a zirconium compound of a salicylic acid derivative is used as the charge control agent.

Thus, a toner of an embodiment of the present invention is a full-color toner for electrophotography which comprises: a binder resin; a wax; a colorant; and a charge control agent, wherein the toner is produced by melt-kneading using an open-roll kneader, wherein Mze/Mzi is 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and wherein a zirconium compound of a salicylic acid derivative is used as the charge control agent.

“Z-average molecular weight” as used herein will be described below.

When measuring the molecular weight of a polymer material, it is imperative to employ “weighted average” since the polymer offers a molecular weight distribution. When the molecular weight is measured experimentally, a certain average value yields.

Assuming the molecule weight is Mμ and the number of molecules is nμ, number-average molecular weight is defined as:

$${\overline{M}}_{n} = \frac{{\sum }_{μ = 1}^{∞} {M}_{μ} {n}_{μ}}{{\sum }_{μ = 1}^{∞} {n}_{μ}}$$

This molecular weight is based on the number of molecules and can be found by quantification of end groups or by membrane osmometry. The number-average molecular weight is highly susceptible to low-molecular weight components contained in the polymer.

Meanwhile, weight-average molecular weight, which places strong focus on high-molecular weight components contained in the polymer, is defined as:

$${\overline{M}}_{w} = \frac{{\sum }_{μ = 1}^{∞} {M}_{μ}^{2} {n}_{μ}}{{\sum }_{μ = 1}^{∞} {M}_{μ} {n}_{μ}}$$

The weight-average molecular weight is found by light scattering method. Z-average molecular weight, which places stronger focus on high-molecular weight components than does weight-average molecular weight, is defined as:

$${\overline{M}}_{Z} = \frac{{\sum }_{μ = 1}^{∞} {M}_{μ}^{3} {n}_{μ}}{{\sum }_{μ = 1}^{∞} {M}_{μ}^{2} {n}_{μ}}$$

The Z-average molecular weight used in a polymer material consisting of polymer components with different molecular weights is an average molecular weight that places higher importance on the extent to which the polymer components contribute to the polymer material's average molecular weight than does the weight-average molecular weight. In general, the Z-average molecular weight is a value calculated by dividing a sum of the cubes of the masses of the polymer components belonging to respective channels (narrow molecular weight ranges) by a sum of the squares of the masses of the polymer components in question as follows:

$$Mz = \frac{{\sum }_{i = 1}^{∞} {Mi}^{3} Ni}{{\sum }_{i = 1}^{∞} {Mi}^{2} Ni}$$

It should be noted that the molecular weight distribution of the resin component in the melt-kneaded product to be discharged is substantially identical to that of the resin component measured after pulverization and classification processes. Thus, the measurement of the molecular weight distribution for calculation of Z-average molecular weight (Mze) can be carried out after pulverization and classification.

The Z-average molecular weight principally indicates bending fatigue and rigidity, thus indicating the degree of elasticity. More specifically, changes in the Z-average molecular weight indicates the occurrence of molecular breakage, and the magnitude of the changes is considered to indicate the level of shearing force applied during melt-kneading. The change ratio of the Z-average molecular weight (Mze/Mzi) in the range of 0.3 to 0.7 indicates that high shearing force is applied, whereas a change ratio (Mze/Mzi) of greater than 0.7 indicates that somewhat high shearing force is applied enough to cause molecular breakage; however, in this case, wax components are not sufficiently dispersed, resulting in image disturbance and soiling of the charging member during running and leading to reduced charge amount. A change ratio (Mze/Mzi) of less than 0.3 results in failure to effectively prevent hot offset even if a zirconium compound of a salicylic acid derivative is used. Such a zirconium compound is employed since it has white color and thus less affects color toner and since it not only offers excellent environmental stability and charge rise property, but forms pseudo-crosslink structure with a carboxylic acid of binder resin (although the mechanism still remains elusive) so that high hot offset resistance is obtained while retaining low-temperature fixing property.

A toner of an embodiment of the present invention is characterized in that a charge control agent is added in an amount of 0.5 parts by mass to 3 parts by mass per 100 parts by mass of resin. A charge control agent content of less than 0.5 parts by mass results in poor environmental stability, poor formation of pseudo-crosslink structure with the binder resin, and poor hot offset prevention. A charge control agent content of greater than 3 parts by mass results in difficulty in dispersing the charge control agent and prevents smooth charge transportation, leading to poor charge rise property and background fogging due to reduced charge amount. In addition, color reproducibility is deteriorated in the case of color toner. If the charge control agent content is 0.5 parts by mass to 3 parts by mass per 100 parts by mass of binder resin, it is possible to obtain a toner with excellent environmental stability, charge ability, and hot offset resistance.

A toner of an embodiment of the present invention is characterized in that the charge control agent, exposed to the toner surface, has an average particle diameter of 0.7 μm or less. If particles of the charge control agent are poorly dispersed, they exist on the toner surface as coarse particles. This prevents smooth charge transportation and deteriorates charge rise property, leading to background fogging due to reduced charge amount. Moreover, this inhibits formation of the network or pseudo-crosslink structure formed between the charge control agent and binder resin, leading to poor hot offset resistance. If the average particle diameter of the charge control agent exposed on the toner surface is 0.7 μm or less, particles of the charge control agent are uniformly dispersed, providing a toner with stable charge performance and excellent hot offset resistance.

A toner of an embodiment of the present invention is characterized in that it employs a polyester resin as a binder resin. This is because polyester resins not only have high transparency when used as binder resin for full-color toner, but have a carboxylic acid as a terminal group and thus have a moderate acid value. For these reasons, polyester resins can effectively form pseudo-crosslink structure with a zirconium compound of a salicylic acid derivative used in the present invention, providing excellent hot offset resistance.

A toner of an embodiment of the present invention is characterized in that the binder resin has an acid value of 10 mgKOH/g to 30 mgKOH/g. An acid value of less than 10 mgKOH/g results in failure to form sufficient pseudo-crosslink structure between the binder resin and zirconium compound of salicylic acid derivative. Therefore, sufficient hot offset resistance cannot be obtained. An acid value of greater than 30 mgKOH/g results in successful formation of pseudo-crosslink structure to provide hot offset resistance. Nevertheless, since the binder resin has such a high acid value, it is susceptible to influences of external environments and thereby the charge amount decreases when used in a high-temperature, high-humidity condition, leading to image disturbance such as background fogging. If the acid value of the binder resin is 10 mgKOH/g to 30 mgKOH/g, it is possible to obtain a toner that offers excellent hot offset resistance and causes no image disturbance.

### DETAILED DESCRIPTION OF THE INVENTION

Embodiments of the present invention will be detailed below.

A toner production method of an embodiment of the present invention includes mixing, melt-kneading, cooling, primary crushing, pulverization, classification of toner materials, and addition of external additive thereto. An open-roll kneader is employed as a melt-kneader. The open-roll kneader used in the present invention is preferably a kneader that includes at least one pair of rolls disposed in proximity of each other, with a continuous two-open roll kneader being more preferable in view of production efficiency and device simplicity.

The clearance or gap between the two rolls disposed in proximity of each other can be determined freely, and the two rolls may be provided either in parallel or in non-parallel arrangement. The roll clearance at the kneaded product-discharging side is made wider than the roll clearance at the toner material-charging side, whereby the kneading force of the open-roll kneader, which otherwise applies high shearing force over the entire kneaded product, is converged at the toner material-charging side (first half of the material) and the latter half of the material is kneaded primarily by means of melting. In this way generation of heat associated with kneading can be suppressed, providing higher kneading effects. It is preferable that one of the two rolls be a heat roll in which a heating medium is provided, and that the other roll be a cooling roll in which a cooling medium is provided. The temperature of the heating medium is preferably set to a temperature falling within ±30° C. of the softening of the binder resin. There is no specific restrictions on the structure, size, and material of the rolls; the roll surface may be any of flat surface, wave surface, convex-concavo surface, etc. The rotational speed of the rolls is preferably 2-100 m/min in terms of circumferential speed. The rotational speed ratio between the two rollers (number of revolutions of the cooling roll/number of revolutions of the heat roll) is preferably 1/10 to 9/10. A desired kneading force can be obtained by adjusting the kneading temperature and rotational speeds of the rolls.

The binder resin used in the present invention is not particularly limited and, preferably, polyester resins are used. From polyester resins, those having a desired acid value can be easily selected. Polyester resins are preferably used for forming a full-color toner, since they desirably control thermal characteristics of the toner. Specifically, the polyester resins can be synthesized through reaction between below-listed polyhydric alcohols and below-listed polycarboxylic acids. Examples of the polyhydric alcohols include dihydric alcohols such as ethylene glycol, 1,2-propylene glycol, 1,3-propylene glycol, 1,4-butanediol, 2,3-butanediol, diethylene glycol, triethylene glycol, 1,5-pentanediol, 1,6-hexanediol, neopentylene glycol, 1,4-cyclohexanedimethanol, dipropylene glycol, polyethylene glycol, polypropylene glycol, bisphenol A, hydrogenated bisphenol A, and alkylene oxide adducts of bisphenol A (e.g., polyoxyethylenated bisphenol A and polyoxypropylenated bisphenol A).

In addition, tri- or more-hydric alcohols may be used so that the polymer is non-linearilized to an extent that no tetrahydrofuran-insoluble components result.

Examples of the tri- or more-hydric alcohol include glycerin, sorbitol, 1,2,3,6-hexanetetraol, 1,4-sorbitan, pentaerythritol, 1,2,4-butanetriol, 1,2,5-pentanetriol, 2-methylpropanetriol, 2-methyl-1,2,4-butanetriol, trimethylolethane, trimethylolpropane, and 1,3,5-trihydroxymethylbenzene.

Examples of the polycarboxylic acid include dibasic carboxylic acids such as maleic acid, fumaric acid, mesaconic acid, citraconic acid, itaconic acid, glutaconic acid, phthalic acid, terephthalic acid, isophthalic acid, cyclohexanedicarboxylic acid, malonic acid, succinic acid, adipic acid, sebacic acid, glutaric acid, alkylsuccinic acids (e.g., n-octylsuccinic acid and n-dodecenylsuccinic acid), anhydrides thereof, and alkyl esters thereof.

The binder resins used in the present invention preferably have an acid value of 10 mgKOH/g to 30 mgKOH/g.

Colorants for forming yellow-, magenta-, cyan- or black-toner may be those known in the art.

Examples of the colorant for forming yellow toner include azo pigments such as C.I. Pigment Yellow 1, C.I. Pigment Yellow 5, C.I. Pigment Yellow 12, C.I. Pigment Yellow 15 and C.I. Pigment Yellow 17; inorganic pigments such as yellow iron oxide and yellow ochre; and dyes such as nitro dyes (e.g., C.I. Acid Yellow 1) and oil-soluble dyes (e.g C.I. Solvent Yellow 2, C.I. Solvent Yellow 6, C.I. Solvent Yellow 14, C.I. Solvent Yellow 15, C.I. Solvent Yellow 19 and C.I. Solvent Yellow 21). In particular, benzidine pigments such as C.I. Pigment Yellow 17 are preferred from the viewpoint of providing excellent tint.

Examples of the colorant for forming magenta toner include C.I. Pigment Red 49, C.I. Pigment Red 57, C.I. Pigment Red 81, C.I. Pigment Red 122, C.I. Solvent Red 19, C.I. Solvent Red 49, C.I. Solvent Red 52, C.I. Basic Red 10 and C.I. Dispersed Red 15. In particular, quinacridone pigments such as C.I. Pigment Red 122 are preferred from the viewpoint of providing excellent tint.

Examples of the colorant for forming cyan toner include C.I. Pigment Blue 15, C.I. Pigment Blue 16, C.I. Solvent Blue 55, C.I. Solvent Blue 70, C.I. Direct Blue 25 and C.I. Direct Blue 86. In particular, copper phthalocyanine pigments such as C.I. Pigment Blue 15 are preferred from the viewpoint of providing excellent tint.

The colorant for forming black toner is preferably carbon black. The carbon black may be appropriately selected from conventionally known carbon blacks such as channel black, roller black, disk black, gas furnace black, oil furnace black and acetylene black.

Examples of the wax used in the present invention include natural waxes such as bees wax, whale wax, shellac wax (these are derived from animals), carnauba wax, Japan wax, rice wax, candelilla wax (these are derived from vegetables), paraffin wax, microcrystalline wax (these are derived from petroleum), montan wax, ozokelite (these are derived from mineral); and synthetic waxes such as Fischer-Tropsch wax, polyethylene wax, synthetic oil and fat wax (esters, ketones and amides) and hydrogenated wax. In order for the wax component to exude at low temperatures, it is preferable to employ a wax with an endotherm peak of 80° C. to 110° C. as measured with a differential scanning calorimeter (hereinafter abbreviated as “DSC”). Among them, preferred are synthetic hydrocarbon waxes obtained through synthesis and petroleum waxes, which should not be construed as limiting the wax used in the present invention thereto. The synthetic hydrocarbon waxes are broadly classified into the following two types. One is called Fischer-Tropsch waxes, which are produced by reacting carbon monoxide with hydrogen. The other is called polyethylene waxes, which are produced through polymerization of ethylene or through pyrolysis of polyethylene.

The toner of the present invention contains, as a charge control agent, a zirconium compound of a salicylic acid derivative. The salicylic acid derivative-zirconium compounds are white and can be used for forming color toner. Also, these compounds have a salt structure containing a trivalent metal and thus, offer excellent charge receiving/transporting capability, charge rise property, and environmental stability. Furthermore, these compounds can form pseudo-crosslink structure together with carboxylic acids of binder resin (note that underlying mechanism is unclear), which provides advantageous effects on hot offset resistance while maintaining desired low-temperature fixing property.

The toner used in an embodiment of the present invention contains zirconium salicylate in order to control its charge ability with friction as well as form a pseudo-crosslink structure together with binder resin. The amount of zirconium salicylate added is 0.1 parts by mass to 5 parts by mass, preferably 0.5 parts by mass to 3 parts by mass, per 100 parts by mass of the binder resin.

The charge control agent used in the present toner preferably have an average dispersed-particle diameter of 0.7 μm or less as measured on the toner surface. The average dispersed-particle diameter of the charge control agent can be determined using a backscattered electron image of toner particles obtained through scanning electron microscopy. Specifically, it is calculated by averaging the particle diameters of the charge control agents detectable in this backscattered electron image.

The toner used in an embodiment of the present invention further contains inorganic microparticles and resin microparticles. Examples of the inorganic microparticles include fatty acid metal salts, zinc stearate, calcium stearate, lead stearate, zinc oxide powder, aluminum oxide powder, titanium oxide powder and silica fine powder. The resin microparticles employed are made of melamine resin.

The toner particles used in an embodiment of the present invention have an average particle diameter of 3 μm to 15 μm. When high-quality images are intended to be formed, small toner particles with an average particle diameter of 9 μm or less are used. When image quality is intended to be improved, small toner particles with an average particle diameter of 5 μm to 8 μm are preferably used.

The average molecular weight of toner can be measured through, for example, gel permeation chromatography (hereinafter abbreviated as “GPC”). In GPC, the toner is dissolved in THF, and then the solution is caused to pass through a column packed with porous gel having a controlled pore size to fractionate and elute the sample through the porous structure based on the difference in migration speed attributed to the polymer shape. The sample was prepared as follows: toner (15 mg) was dissolved in THF (10 mL); and the solution was stirred with a roll mill for 10 min and filtered with a Myshori Disk.

### EXAMPLES

### Examples 1 to 6 and Comparative Examples 1 to 3

A binder resin (100 parts by mass), a charge control agent, paraffin wax as a releasing agent (5 parts by mass), CI. PIG. B-15:3 as a colorant for cyan toner (5 parts by mass) were mixed in a Henschel mixer. The mixtures were melt-kneaded with an open-roll kneader, and the kneaded products were pulverized and classified to form toners with an average particle diameter of 7 μm. Thereafter, hydrophobic silica with a primary particle diameter of 12 nm was added to each toner. The resultant toners were used for evaluation. Table 1 shows the types of the binder resin, the acid values thereof, and the types of the charge control agent.

Notably, each of the mixtures obtained after mixing with a Henschel mixer was measured for its molecular weight distribution (Mzi), and the pulverized/classified product thereof was measured for its molecular weight distribution (Mze), whereby the value Mze/Mzi was calculated (shown in Table 1). Further, the average dispersed-particle diameter of the charge control agents was measured in a manner described above (shown in Table 1).

TABLE 1

| | | Charge control agent | | | | |
|---|---|---|---|---|---|---|
| | | | | Average | | |
| | | | Amount | particle | Binder resin | |
| | | | (parts by | diameter | | Acid value |
| | Mze/Mzi | Type | mass) | (μm) | type | (mgKOH/g) |
| Ex. 1 | 0.4 | Zirconium salicylate | 4 | 0.9 | Styrene-acrylic resin | 35 |
| Ex. 2 | 0.6 | Zirconium salicylate | 2 | 0.9 | Styrene-acrylic resin | 8.7 |
| Ex. 3 | 0.6 | Zirconium salicylate | 4 | 0.6 | Styrene-acrylic resin | 8.7 |
| Ex. 4 | 0.6 | Zirconium salicylate | 4 | 0.9 | Polyester resin | 35.3 |
| Ex. 5 | 0.6 | Zirconium salicylate | 4 | 0.9 | Polyester resin | 25.2 |
| Ex. 6 | 0.6 | Zirconium salicylate | 4 | 0.9 | Polyester resin | 13.8 |
| Comp. | 0.6 | Zinc salicylate | 4 | 0.9 | Styrene-acrylic resin | 8.7 |
| Ex. 1 | | | | | | |
| Comp. | 0.8 | Zirconium salicylate | 4 | 0.9 | Styrene-acrylic resin | 8.7 |
| Ex. 2 | | | | | | |
| Comp. | 0.2 | Zirconium salicylate | 4 | 0.9 | Styrene-acrylic resin | 8.7 |
| Ex. 3 | | | | | | |

### <Evaluation Method>

### (Fixing Test)

Each of the above-prepared toners and ferrite carriers (60 μm) were stirred/mixed with a toner concentration of 4% for 20 minutes to thereby form a two-component developer. Using the two-component developer, unfixed images with a developer deposition amount of 4.0 g/m² were formed with a copier (Imagio Neo C355, product of Ricoh Company Ltd.). The unfixed images were caused to pass through an external fixing machine at a constant feed speed of 120 mm/sec. This external fixing machine had been prepared by remodeling a oil-less fixing device of a copier (Imagio Neo C355, product of Ricoh Company Ltd.) so that the temperature of the roller could be set as desired. During this feeding, the roller temperature was changed in increments of 10° C. from 100° C. to 210° C. Through observation of the fixing roller and sheet for the occurrence of offset, a phenomenon where unwanted image is re-transferred on non-printing portions. The temperatures at which no re-transfer of image had been observed were defined as non-offset temperatures. The developer was measured for the range of the non-offset temperature and evaluated according to the following criteria:

Non-offset temperature range of 70° C. or wider: A

Non-offset temperature range of 50° C. or wider and narrower than 70° C.: B

Non-offset temperature range of narrower than 50° C.: C.

Evaluation results are shown in Table 2.

### (Long-Term Running Test)

Using a copier (Imagio Neo C355, product of Ricoh Company Ltd.), the two-component developer was evaluated for its printing durability at normal temperature/normal humidity (25° C./50%) and at high temperature/high humidity under the following conditions: a printing density: 5% and the number of sheets printed: 50,000. The 1st and the 50,000th fixed images were compared with a new sheet for the image density of their white areas using a reflection densitometer (product of Macbeth Co.). The determined differences in image density were evaluated according to the following criteria:

Difference of 0.01 or less: A

Difference between 0.01 (exclusive) and 0.02 (inclusive): B

Difference between 0.02 (exclusive) and 0.03 (inclusive): C

Difference of more than 0.03: D.

The evaluation results are shown in Table 2.

TABLE 2

| | Fixing | | Long-term running (25° C./50%) | | | | Long-term running (35° C./80%) | | | | |
|---|---|---|---|---|---|---|---|---|---|---|---|
| | property | | Initial sheet | | 50,000th sheet | | Initial sheet | | 50,000th sheet | | |
| | Non-offset | | Background | | Background | | Background | | Background | | Overall |
| | range | Rank | fogging | Rank | fogging | Rank | fogging | Rank | fogging | Rank | Evaluation |
| Ex. 1 | 145-200 | B | 0.013 | B | 0.016 | B | 0.018 | B | 0.023 | C | B |
| Ex. 2 | 140-190 | B | 0.006 | A | 0.011 | B | 0.012 | B | 0.018 | B | A |
| Ex. 3 | 140-200 | B | 0.004 | A | 0.009 | A | 0.008 | A | 0.013 | B | A |
| Ex. 4 | 145-220 | A | 0.012 | B | 0.018 | B | 0.015 | C | 0.021 | C | B |
| Ex. 5 | 135-210 | A | 0.009 | A | 0.012 | B | 0.012 | B | 0.017 | B | A |
| Ex. 6 | 130-210 | A | 0.007 | A | 0.013 | B | 0.015 | B | 0.017 | B | A |
| Comp. | 145-185 | C | 0.008 | A | 0.015 | B | 0.013 | B | 0.018 | B | D |
| Ex. 1 | | | | | | | | | | | |
| Comp. | 145-220 | A | 0.021 | C | 0.028 | C | 0.025 | C | 0.033 | D | D |
| Ex. 2 | | | | | | | | | | | |

The toner composition of Comparative Example 1 contains, as a charge control agent, zinc salicylate which do not form pseudo-crosslink structure together with binder resin. Thus, the toner produced with an open-roll kneader was found to have a narrow non-offset range on fixation and to be difficult to practically use.

The toner of Comparative Example 2 was found to be treated with low shearing force. This had insufficient dispersibilty of wax and adhered to charging members, causing background fogging due to decrease in charging after the long-term running.

The toner of Comparative Example 3 was found to be treated with too strong shearing force applied by an open-roll kneader. This had good dispersibility of wax, but had a narrow offset range, in particular, low high-temperature offset resistance.

The toners of Examples 1 to 6 had a broad non-offset range and exhibited good long-term running performance even under high-temperature, high-humidity conditions.

In the full-color toner for electrophotography that includes a binder resin, a wax, a colorant, and a charge control agent and that is produced by melt-kneading using an open-roll kneader, Mze/Mzi is set to 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and a zirconium compound of a salicylic acid derivative is used as the charge control agent, whereby the toner offers excellent fixing characteristics and long-term running characteristics even under high-temperature, high-humidity conditions.

What is claimed is:

1. A production method for a full-color toner for electrophotography, comprising:
melt-kneading a toner material by use of an open-roll kneader, the toner material containing at least a binder resin, a wax, a colorant, and a charge control agent,
wherein Mze/Mzi is 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and
wherein a zirconium compound of a salicylic acid derivative is used as the charge control agent.

2. The production method according to claim 1, wherein the charge control agent is added in an amount of 0.5 parts by mass to 3 parts by mass per 100 parts by mass of the resin.

3. The production method according to claim 1, wherein the charge control agent, exposed on a toner surface, has an average particle diameter of 0.7 μm or less.

4. The production method according to claim 1, wherein a polyester resin is used as the binder resin.

5. The production method according to claim 1, wherein the binder resin has an acid value of 10 mgKOH/g to 30 mgKOH/g.

6. A full-color toner for electrophotography comprising:
a binder resin;
a wax;
a colorant; and
a charge control agent,
wherein the toner is produced by melt-kneading using an open-roll kneader,
wherein Mze/Mzi is 0.3 to 0.7, where Mze is a Z-average molecular weight of a resin component of the toner material to be supplied in the open-roll kneader, and Mzi is a Z-average molecular weight of a resin component of a kneaded product to be discharged from the open-roll kneader, and
wherein a zirconium compound of a salicylic acid derivative is used as the charge control agent.

7. The full-color toner according to claim 6, wherein the charge control agent is added in an amount of 0.5 parts by mass to 3 parts by mass per 100 parts by mass of the resin.

8. The full-color toner to claim 6, wherein the charge control agent, exposed on a toner surface, has an average particle diameter of 0.7 μm or less.

9. The full-color toner according to claim 6, wherein a polyester resin is used as the binder resin.

10. The full-color toner according to claim 6, wherein the binder resin has an acid value of 10 mgKOH/g to 30 mg/KOH/g.
